(19) United States
(12) Patent Application Publication
(10) Pub. No.: US 2013/0036816 A1
(43) Pub. Date: Feb. 14, 2013

(54) Apparatus for determining and/or monitoring a process variable of a medium

(71) Applicants: Martin Urban, Lorrach (DE); Tobias Brengartner, Emmendingen (DE)

(72) Inventors: Martin Urban, Lorrach (DE); Tobias Brengartner, Emmendingen (DE)

(73) Assignee: Endress + Hauser GmbH +Co. KG, Maulburg (DE)

(21) Appl. No.: 13/643,605

(22) PCT Filed: Mar. 24, 2011
(86) PCT No.: PCT/EP2011/054522

§ 371 Date: Oct. 26, 2012

(30) Foreign Application Priority Data
Apr. 28, 2010 (DE) 102010028303.7

(51) Int. Cl. G01N 11/16; G01F 23/00; G01N 9/00

(52) U.S. Cl. 73/32 A; 73/54.41; 73/54.02; 73/290 V

(57) ABSTRACT

An apparatus for determining and/or monitoring at least one process variable, especially a fill level, a density or a viscosity, of a medium in a container, including: a mechanically oscillatable structure protruding into the container during operation, with at least one oscillatory characteristic dependent on the process variable; an electromechanical transducer; and electronics, for producing an exciter signal connected to the input side of the transducer, which has a first filter, wherein the first filter filters out a wanted signal from the received signal; and which determines and/or monitors the process variable based on the wanted signal. The apparatus has high quality, disturbance signal suppression, which assures a signal transmission as uncorrupted as possible over the total wanted frequency range of the apparatus and which is effected by features including that the first filter is a band pass filter with an adjustable center frequency and the electronics includes an apparatus, which during operation sets the center frequency to the frequency of the exciter signal.

The invention relates to an apparatus for determining and/or monitoring at least one process variable, especially a fill level, a density or a viscosity, of a medium in a container. The apparatus includes: A mechanically oscillatable structure protruding into the container, wherein the oscillatable structure has at least one oscillatory characteristic dependent on the process variable; an electromechanical transducer, which excites the oscillatable structure to execute mechanical oscillations by means of an exciter signal supplied on the input side of the transducer, and which converts the resulting oscillations of the oscillatable structure to an electrical received signal representing the oscillation and outputs this signal; and an electronics, which includes an apparatus for producing the exciter signal connected on the input side of the transducer, and which determines and/or monitors the process variable based on the received signal.

Such apparatuses are applied in a large number of industrial applications, especially in measuring and control technology and process automation, for determining and/or monitoring the said process variables.

In the case of the most well known apparatuses of this type, the mechanically oscillatable structure includes two oscillatory fork tines coupled by a membrane; the oscillatory tines are set in counterphase oscillations perpendicular to their longitudinal axes by an electromechanical transducer mounted on the rear side of the membrane facing away from the oscillating rods. also known are apparatuses, whose oscillatable structure has only one oscillatory rod or simply an oscillatable membrane.

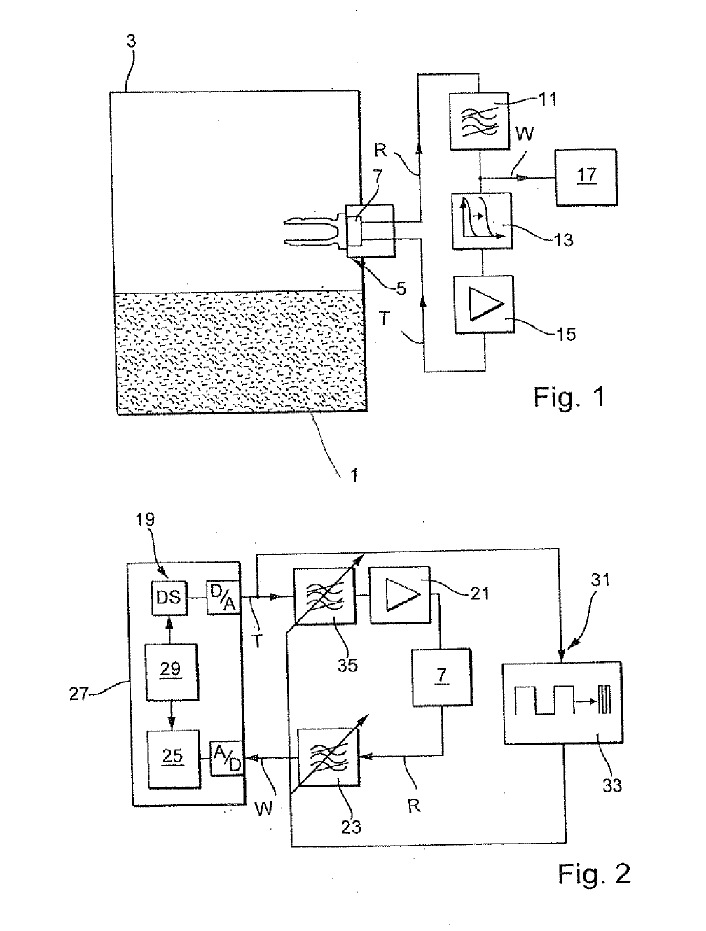

FIG. 1 shows a classic example of a corresponding apparatus, as it is applied for monitoring a certain fill level of a medium 1 in a container 3. The mechanically oscillatable structure 5 includes here two oscillatory tines, or rods, coupled by a membrane. The oscillatory rods are inserted laterally into container 3 at the height of the fill level to be monitored. Oscillatable structure 5 is caused to oscillate, for example, by an electromechanical transducer 7—here illustrated only schematically—arranged on the rear side of the membrane. This is caused to happen by features including that the received signal R of transducer 7, which represents the oscillation, is lead back as a transmitted exciter signal T to transducer 7 via a feedback path containing a band pass filter 11, a phase shifter 13 and an amplifier 15. Transducer 7, in conjunction with oscillatable structure 5, forms, in such case, the frequency determining element of an electrical oscillatory circuit, which is operated preferably in resonance. For this, a phase shift between exciter signal T and received signal R is specified by the phase shifter to fulfilled, as accurately as possible, the resonance condition for the oscillatory circuit. Oscillatable structure 5 is thereby excited to oscillate at an oscillation frequency fᵣ, which is determined by the phase shift and lies in the region of the resonance frequency of oscillatable structure 5.

In parallel therewith, received signal R is fed as wanted signal W to a measuring and evaluation unit 17, which, based on the wanted signal W, determines the oscillatory characteristic dependent on the process variable and, based on such characteristic, determines and/or monitors the process variable. For fill level monitoring, for example, the oscillation frequency fᵣ of oscillatable structure 5 arising from the predetermined phase shift is measured and compared to a limit frequency determined earlier. If the oscillation frequency fᵣ is greater than the limit frequency, then oscillation structure 5 is oscillating freely. If the oscillation frequency fᵣ lies below the limit frequency, then oscillation structure 5 is covered by medium 1 and the apparatus reports an exceeding of the specified fill level.

Alternatively, in the case of a perpendicular insertion of a rod or fork shaped oscillatable structure into the medium with a corresponding calibration based on the oscillation frequency arising at the predetermined phase shift, the degree of covering, and therewith the fill level, can be measured over the length of the oscillatable structure.

For determining and/or monitoring the density or viscosity of the medium, the structure is inserted perpendicularly in the medium to a predetermined immersion depth, and the oscillation frequency resulting at the predetermined phase shift, or, in the case of excitation with a fixed excitation frequency, the oscillation amplitude or the phase shift of the oscillation compared to the exciter signal is measured.

An alternative form of excitation is provided by the frequency sweep described, for example, in DE 100 50 299 A1, in the case of which the frequency of the exciter signal periodically passes through a predetermined frequency range. Also here, the process variable is determined and/or monitored, for example, based on the amplitude or the phase shift of the resulting oscillation.

Regardless of whether the apparatus is continuously excited to oscillations with the oscillation frequency fᵣ arising in the case of a predetermined phase shift, is operated with the frequency sweep method or is operated with a fixed, predetermined excitation frequency, a disturbance signal suppression is desirable, which eliminates disturbance signals caused e.g. by grid humming, external vibrations at the location of use of the apparatus or parasitic couplings. Moreover, the received signal, especially in the case of excitation by rectangular exciter signals, can contain disturbance signals attributable to excited, higher oscillation modes. These disturbance signals coming from higher oscillation modes should, likewise, be suppressed.

Currently, disturbance signal suppression occurs, for example, via a filter applied in the feedback loop. In such case, there is the problem that the filter, on the one hand, should assure a signal transmission as uncorrupted as possible for the total wanted frequency range of the received signal representing the oscillation, and, on the other hand, should suppress disturbance signals as much as possible. While a broad band filter is required for uncorrupted signal transmission, a narrow band filter is required for disturbance signal suppression.

Since these requirements are mutually exclusive, a compromise, which satisfies both requirements as well as possible, is required. This means both lessening of the uncorrupted signal transmission as well as lessened disturbance signal suppression.

A particular problem, in such case, are the phase shifts caused by the filter. As a rule, these phase shifts, which are strongly dependent on frequency, lead, in the case of excitation by an oscillatory circuit, to the resonance condition for the oscillatory circuit, which assumes a fixed phase relationship between the excitation signal and the received signal, not being equally fulfilled for all oscillation frequencies arising as a function of the process variable.

Moreover, they lead, in the case of filtering the received signal R to obtain a wanted signal W with a low disturbance, to degradations in the achievable accuracy and reliability in determining and/or monitoring the process variable, since the phase relationship of the wanted signal derived from the received signal is changed in a frequency dependent manner by the filtering. The extent of the measurement accuracy is dependent on the measuring and evaluation method applied. Measuring and evaluation methods, which operate based on a measuring of the phase relationship of the wanted signal as well as measuring and evaluation methods, which evaluate the wanted signal at a predetermined phase shift, are especially affected.

It is an object of the invention to provide an apparatus for determining and/or monitoring at least one process variable of the type mentioned above, wherein the apparatus has a high quality, disturbance signal suppression, which assures a signal transmission as uncorrupted as possible over the total wanted frequency range of the apparatus.

The object is achieved according to the invention by features including that
the electronics has a first filter connected to the output side of the transducer, wherein the first filter filters out a wanted signal from the received signal, and the electronics determines and/or monitors the process variable based on the wanted signal;
the first filter is a switched capacitor filter, which has at least one capacitor switched with a switching frequency, and whose center frequency is adjustable via the switching frequency; and
the electronics includes an apparatus, which during operation sets the center frequency to the frequency of the exciter signal.

In a further development, the electronics includes a second filter arranged between the apparatus for producing the exciter signal and the transducer. The second filter is a band pass filter with an adjustable center frequency and the apparatus during operation sets the center frequency of the second filter to the frequency of the exciter signal.

In a preferred embodiment, the second filter is a switched capacitor filter, which has at least one switched capacitor with a switching frequency, and whose center frequency is adjustable via the switching frequency.

In an additional embodiment, the switching frequency is a multiple of the frequency of the exciter signal.

In an additional embodiment of the preferred embodiment
the apparatus for adjusting the center frequency of the filter includes a frequency multiplier, especially a phase lock loop,
   to whose input the exciter signal is applied,
   which produces an output signal, whose frequency is a multiple of the frequency of the exciter signal, and
   whose output signal is applied to the filters as a control signal for adjusting the switching frequency of the filter.

In an additional preferred embodiment, the electronics includes an electronic unit, especially a microcontroller,
in which the apparatus for producing the exciter signal is integrated, and
which receives the wanted signal and determines and/or monitors the process variable based on the wanted signal.

In a preferred variant, the exciter signal is a rectangular alternating voltage.

In an additional preferred variant, the frequency of the exciter signal periodically passes through a predetermined frequency range.

The invention and its advantages will now be explained in greater detail based on the figures of the drawing, in which an example of an embodiment is presented; equal parts are provided with the equal reference characters in the figures. The figures of the drawing show as follows:

FIG. 1 an apparatus for monitoring a predetermined fill level, wherein the transducer forms a frequency determining element of an electrical oscillatory circuit; and

FIG. 2 a circuit diagram of an apparatus of the invention.

FIG. 2 shows a circuit diagram of an apparatus of the invention for determining and/or monitoring at least one process variable, especially a fill level, a density or a viscosity, of a medium 1 in a container 3 (not shown in FIG. 2). The apparatus includes a mechanically oscillatable structure 5—here likewise not illustrated—protruding into container 3 during operation. Oscillatable structure 5 has at least one oscillatory characteristic dependent on the process variable.

Oscillatable structure 5 is, for example, the oscillatable structure 5 shown in FIG. 1 with the two oscillatory rods coupled by the membrane. Alternatively, an oscillatable structure having only one oscillatory rod or just an oscillatable membrane can also be applied.

An electromechanical transducer 7 is provided, which excites oscillatable structure 5 to execute mechanical oscillations by means of an exciter signal T supplied to the input side of transducer 7, and which converts the resulting oscillations of structure 5 into an electrical received signal R representing the oscillation and outputs the signal at an output. Piezoelectric transducers known from the state of the art are especially suited for this. Alternatively, however, electromagnetic or magnetostrictive transducers can also be applied.

Furthermore, the apparatus has an electronics, which includes an apparatus 19 connected to the input side of transducer 7 for producing an exciter signal T. In the illustrated example of an embodiment, apparatus 19 includes a digital signal generator DS, which delivers a digital output signal, which via a digital analog converter D/A is converted to an analog alternating voltage signal that is then applied as exciter signal T via an amplifier 21 to the input side of transducer 7.

Moreover, the electronics includes a first filter 23 connected to the output side of transducer 7. First filter 23 filters out a wanted signal W from the received signal R, and feeds such wanted signal W to a measuring and evaluating unit 25, which determines, based on wanted signal W, the oscillatory characteristic dependent on the process variable and based on the oscillatory characteristic then determines and/or monitors the process variable.

Apparatus 19 for producing exciter signal T and the measuring and evaluating system 25 are preferably integral components of an intelligent electronic unit 27, especially a microcontroller or an ASIC, which outputs exciter signal T via the integrated digital analog converter D/A, and receives wanted signal W via a likewise integrated analog/digital converter A/D and further processes wanted signal W in digital form. With electronic unit 27, e.g. via an integrated control unit 29, the most varied of excitation methods and their corresponding measuring and evaluation methods can be implemented.

On the one hand, the apparatus can be operated via an exciter signal T having a fixedly predetermined, constant excitation frequency f_{T}. In this way, oscillatable structure 5 is excited to forced oscillations having this frequency. Correspondingly, wanted signal W also exhibits the predetermined frequency of the exciter signal T. The determination of the process variable can occur based on the amplitude of wanted signal W and/or its phase shift from exciter signal T. The wanted frequency f_{W} here equals the excitation frequency f_{T}.

On the other hand, the apparatus can be operated using the frequency sweep method, wherein electronic unit 27 generates an exciter signal T, whose frequency f_{T} periodically passes through a predetermined frequency range Δf_{T}. In this case, oscillatable structure 5 executes forced oscillations, whose frequency follows the periodically varying frequency f_{T} of exciter signal T. Correspondingly, wanted frequency f_{W} of wanted signal W also follows the periodically varying frequency f_{T} of exciter signal T. The determination of the process variable can occur based on the amplitude of wanted signal W and/or its phase shift from exciter signal T over the total wanted frequency range Δf_{W}. The wanted frequency range Δf_{W} corresponds here to the predetermined frequency range Δf_{T} for exciter signal T.

Another operational mode is the continuous excitation of oscillations with an oscillation frequency fᵣ determined by a predetermined phase shift. In this case, the analog feedback loop shown in FIG. 1 is replicated in digital form in unit 29, wherein an exciter signal T is generated, which has the frequency f_{W} of the entering wanted signal W, and which is shifted a predetermined phase difference compared to the wanted signal W for the fulfillment of the resonance condition of the electrical oscillatory circuit. Oscillatable structure 5 performs oscillations at its oscillation frequency fᵣ after a short settling time. Accordingly, both frequency f_{T} of exciter signal T, as well as wanted frequency f_{W} of wanted signal W are equal to the oscillation frequency fᵣ. Wanted frequency range Δf_{W} here corresponds to the frequency range, through which oscillation frequency fᵣ passes as a function of the process variable. The determination of the process variable occurs here, for example, based on a measuring of the oscillation frequency fᵣ.

According to the invention, first filter 23 is a band pass filter with an adjustable center frequency f₀ and the electronics includes an apparatus 31 for adjusting the center frequency f₀ of filter 23. During operation, apparatus 31 tunes the center frequency f₀ to the frequency f_{T} of exciter signal T.

Therewith, filter 23 has, at all times, an optimal center frequency f₀ matched to exciter signal T. The current frequency f_{T} of exciter signal T is, as disclosed earlier based on the different manners of operation, independent of the type of operation of the apparatus and also equals the current wanted frequency f_{W} of wanted signal W. Filter 23 is therewith, at all times, optimally matched to wanted signal W and assures a largely uncorrupted signal transmission of wanted signal W. Especially, filter 23, due to its equally optimal matching of center frequency f₀ for all wanted frequencies f_{W}, effects no frequency-dependent, and therewith variable, phase shifts. This phase locked and uncorrupted signal transmission of wanted signal W is assured even if the arising wanted frequencies f_{W} cover an extremely large wanted frequency range Δf_{W} during operation.

Through the permanent matching of center frequency f₀ to the instantaneous frequency f_{T} of exciter signal T and therewith also to the instantaneous wanted frequency f_{W}, there is an option available to use an extremely narrow band filter, i.e. a filter 23 with a small passband frequency range. Filter 23 no longer needs to be transmissive for the total wanted frequency range Δf_{W} of the apparatus. Correspondingly, disturbance signals can be eliminated very effectively. Especially, disturbance signals lying within the wanted frequency range Δf_{W} of the apparatus can also be suppressed to the extent that their frequencies have a certain minimum separation from the current wanted frequency f_{W}.

Filter 23 is a switched capacitor filter, which has at least one switched capacitor with a switching frequency f_{sc}, and whose center frequency f₀ can be adjusted via the switching frequency f_{sc}.

Apparatus 31, which sets the center frequency f₀ of filter 23 to frequency f_{T} of exciter signal T during operation, generates or controls, in this case, the switching frequency f_{sc} of the switched capacitor filter as a function of the instantaneous frequency f_{T} of exciter signal T. Preferably, a frequency, which is a predetermined multiple of the frequency f_{T} of exciter signal T, is applied as switching frequency f_{sc}. Apparatus 31 for adjusting the center frequency f₀ includes, for this, for example, a frequency multiplier 33, especially a phase lock loop (PLL), to whose input the exciter signal T is applied. Frequency multiplier 33 produces an output signal, whose frequency is a multiple of the frequency f_{T} of exciter signal T, and provides, as a control signal for adjusting the switching frequency f_{sc} of the filter, a corresponding output signal, which is applied to a corresponding control input of filter 23. For achieving a high filter characteristic and high quality, a switching frequency f_{sc} is preferably set, which is a large multiple, e.g. a factor of 100, greater than the center frequency f₀ to be set.

Frequency multipliers 33 are preferably applied in apparatuses of the invention, whose mechanically oscillatable structures 5 oscillate at relatively high frequencies. An example for this are the previously mentioned membrane oscillators, whose membrane typically executes oscillations with frequencies in the range of 15 kHz to 30 kHz.

In conjunction with oscillatable structures 5, which execute oscillations at lower frequencies, apparatus 31 for adjusting center frequency f₀ can alternatively also be embodied as an integral component of electronic unit 27. Examples for this are the previously mentioned oscillatable structures 5, which have one or two oscillatory rods, and typically execute oscillations with frequencies in the region of 300 Hz to 1200 Hz. In this case, the control signal can be generated in electronic unit 27, and from this control signal exciter signal T can be derived by dividing down. Due to the low frequencies, electronic unit 27 is here able to specify the high switching frequencies f_{sc} for achieving the high filter characteristic and high quality desired, without necessitating, for this, extremely high clock rates of unit 27, which would lead to high energy consumption by unit 27.

Preferably, the electronics supplementally includes a second filter 35 arranged between apparatus 19 for producing exciter signal T and transducer 7. The second filter 35 serves, especially in an excitation using rectangular exciter signals T, for conditioning exciter signal T. The second filter 35 filters out an approximately monochromatic signal from the exciter signal T containing higher frequency fractions in certain circumstances. This approximately monochromatic signal is then fed to transducer 7 for exciting the oscillation of oscillatable structure 5. In this way, the excitation of higher oscillation modes, as they especially occur in the application of unfiltered rectangular exciter signals T, is prevented.

Rectangular exciter signals T offer the advantage that they can be produced by electronic unit 29 with clearly less computing power, than is the case, for example, in generating sinusoidal exciter signals digitally. Via second filter 35 it is possible to use rectangular exciter signals T, without a degradation of the signal quality for the oscillation excitement via transducer 7.

Also second filter 35 is a band pass filter with an adjustable center frequency f₀. Center frequency f₀ of this second filter 35 is, exactly as the center frequency f₀ of first filter 23, set, during operation, to the frequency f_{T} of the exciter signal T by means of the apparatus 31 for adjusting the center frequency f₀.

The second filter 35 is preferably identical to first filter and is controlled in parallel with first filter 23 by apparatus 31. Especially, a switched capacitor band pass filter is also preferably applied here, wherein center frequency f₀ of second filter 35 is set via the switching frequency f_{sc}, at which its capacitors are switched, wherein the switching frequency f_{sc} is also here again a multiple of the frequency of exciter signal T.

### LIST OF REFERENCE CHARACTERS

1 medium
3 container
5 mechanically oscillatable structure
7 electromechanical transducer
11 bandpass filter
13 phase shifter
15 amplifier
17 measuring and evaluating unit
19 apparatus for producing the exciter signal
21 amplifier
23 first filter
25 measuring and evaluating unit
27 electronic unit
29 control unit
31 apparatus for adjusting the center frequency of the filter
33 frequency multiplier
35 second filter

1-8. (canceled)

9. An apparatus for determining and/or monitoring at least one process variable, especially a fill level, a density or a viscosity, of a medium in a container, comprising:
a mechanically oscillatable structure protruding into the container during operation, wherein said mechanically oscillatable structure has at least one oscillatory characteristic dependent on the process variable;
an electromechanical transducer, which excites said mechanically oscillatable structure to execute mechanical oscillations by means of an exciter signal supplied to the input of said electromechanical transducer, and which converts the resulting oscillations of said mechanically oscillatable structure to an electrical received signal representing the oscillation and outputs this signal; and
an electronics, which includes an apparatus for producing the exciter signal connected to the input of said electromechanical transducer; which has a first filter connected to the output of said electromechanical transducer, wherein said first filter filters out a wanted signal from the received signal; and which determines and/or monitors the process variable based on the wanted signal, wherein:
said first filter is a switched capacitor filter, which has at least one capacitor switched with a switching frequency, and whose center frequency is adjustable via the switching frequency; and
said electronics includes an apparatus, which during operation sets the center frequency to the frequency of the exciter signal.

10. The apparatus as claimed in claim 9, wherein:
said electronics has a second filter arranged between an apparatus for producing the exciter signal and said electromechanical transducer;
said second filter is a band pass filter with an adjustable center frequency; and
said apparatus of said electronics during operation sets the center frequency of said second filter to the frequency of the exciter signal.

11. The apparatus as claimed in claim 10, wherein:
said second filter is a switched capacitor filter, which has at least one switched capacitor with a switching frequency, and whose center frequency is adjustable via the switching frequency.

12. The apparatus as claimed in claim 9, wherein:
the switching frequency is a multiple of the frequency of the exciter signal.

13. The apparatus as claimed in claim 12, wherein:
said apparatus of said electronics for adjusting the center frequency of said first and second filters includes a frequency multiplier, especially a phase lock loop; to whose input the exciter signal is applied, which produces an output signal, whose frequency is a multiple of the frequency of the exciter signal; and
whose output signal is applied to said first and second filters as a control signal for adjusting the switching frequency of said first and second filters.

14. The apparatus as claimed in claim 1, wherein:
said electronics includes an electronic unit, especially a microcontroller, in which said apparatus for producing the exciter signal is integrated, and which receives the wanted signal and determines and/or monitors the process variable based on the wanted signal.

15. The apparatus as claimed in claim 9, wherein:
the exciter signal is a rectangular alternating voltage.

16. The apparatus as claimed in claim 9, wherein:
the frequency of the exciter signal periodically passes through a predetermined frequency range.
